(19) United States
(12) Patent Application Publication
(10) Pub. No.: US 2013/0302644 A1
(43) Pub. Date: Nov. 14, 2013

(54) HOT ROLLED THIN CAST STRIP PRODUCT AND METHOD FOR MAKING THE SAME

(71) Applicant: NUCOR CORPORATION, Charlotte, NC (US)

(72) Inventors: Daniel Geoffrey EDELMAN, Brownsburg, IN (US); Christopher Ronald KILLMORE, Wollongong (AU); Mary E. ALWIN-BECKER, Crawfordsville, IN (US)

(73) Assignee: NUCOR CORPORATION, Charlotte, NC (US)

(21) Appl. No.: 13/940,601

(22) Filed: Jul. 12, 2013

Related U.S. Application Data
(63) Continuation-in-part of application No. 12/708,635, filed on Feb. 19, 2010.
(60) Provisional application No. 61/154,233, filed on Feb. 20, 2009.

(51) Int. Cl. B22D 11/12; B32B 15/04; B22D 11/06

(52) U.S. Cl. CPC B22D 11/1206; B22D 11/0622; B32B 15/043
USPC 428/659; 164/463; 420/8; 420/87

(57) ABSTRACT

A hot rolled steel strip made by the steps including assembling a twin roll caster, forming a casting pool of molten steel having a free oxygen content between 20 and 75 ppm and having a composition such that the cast strip comprises by weight, greater than 0.1 and not more than 0.5% carbon, between 0.9 and 2.0% manganese, between 0.05 and 0.50% silicon, greater than 0.01% and less than or equal to 0.15% phosphorus, and less than 0.01% aluminum, counter rotating the casting rolls forming the steel strip, hot rolling the strip such that mechanical properties at 10% and 35% reduction are within 10% for yield strength, tensile strength and total elongation, and coiling the strip at a temperature between 300 and 700° C. to provide a majority of the microstructure comprising bainite and acicular ferrite. Alternatively, the steel may have between 0.20 and 0.60% copper and manganese as low as 0.08%.

This application is a continuation-in-part of application Ser. No. 12/708,635 filed Feb. 19, 2010, and claims priority to and the benefit of U.S. Patent Application No. 61/154,233, filed on Feb. 20, 2009, which are incorporated herein by reference.

### BACKGROUND AND SUMMARY

In a twin roll caster, molten metal is introduced between a pair of counter-rotated, internally cooled casting rolls so that metal shells solidify on the moving roll surfaces, and are brought together at the nip between them to produce a solidified strip product, delivered downwardly from the nip between the casting rolls. The term “nip” is used herein to refer to the general region at which the casting rolls are closest together. The molten metal is poured from a ladle through a metal delivery system comprising a tundish and a core nozzle located above the nip to form a casting pool of molten metal, supported on the casting surfaces of the rolls above the nip and extending along the length of the nip. This casting pool is usually confined between refractory side plates or dams held in sliding engagement with the end surfaces of the rolls so as to dam the two ends of the casting pool against outflow. The cast strip is typically directed to a hot rolling mill where the strip is hot reduced by 10% or more.

In the past, plain low carbon steels have been continuously cast on a twin roll caster, including plain carbon-manganese steel. The physical properties of these plain carbon-manganese steels were typically effected by increasing hot rolling reduction. For example, yield strength and tensile strength decreased with increasing amount of hot rolling, while total elongation typically increased with increasing amount of hot rolling. As a result, in the past the steel compositions had to be tailored for the amount of hot rolling reduction that was applied to provide desired mechanical properties. This resulted in inefficiency and operational problems as melt shops had to provide different molten compositions for different hot rolled strip thickness to provide desired hot rolled steel properties.

Additionally, the steel compositions may include copper from scrap products incorporated into the molten steel. In the past, copper levels over about 0.2 weight % were generally avoided because of concerns over “hot shortness” during hot rolling reduction, which causes cracks or extremely roughened surfaces on the strip, sometimes referred to as “checking.” In cases where copper levels were higher than 0.2% (such as in steels with improved atmospheric weathering resistance), expensive additions such as nickel had to be added to reduce the risk of hot shortness.

The problem of hot shortness has increased the costs of making low alloy steel using electric arc furnaces to form the molten carbon steel. Approximately 75% of the cost of making steel by electric arc furnace is the cost of the scrap used as the starting material for charging the electric arc furnace. Steel scrap has been traditionally separated by copper content to less than 0.15% by weight copper, greater than or equal to 0.15% up to 0.5% by weight copper, and above 0.5% by weight copper. Scrap with copper content above 0.5% copper could be mixed with scrap with low copper levels to make an acceptable scrap. In any event, the scrap copper content below 0.15% by weight is the highest cost scrap, with the other two grades of scrap being of less cost. Scrap with less than 0.15% copper is generally useful in electric arc furnaces for certain commercial methods of making steel, adding considerably to the cost of the steel sheet produced. Scrap grades with copper content up to 0.5% have been useful in bar mills serviced by electric arc furnaces, or in other processes at considerable expense by mixing with scrap of lower copper content to reduce the overall copper content of the scrap to less than 0.15%.

Presently disclosed is a hot rolled steel strip and method of making the same comprising the steps of:

(a) assembling internally a cooled roll caster having laterally positioned casting rolls forming a nip between them,

(b) forming a casting pool of molten steel supported on the casting rolls above the nip and confined adjacent the ends of the casting rolls by side dams, the molten steel having a free oxygen content between 20 and 75 ppm and a composition such that hot rolled thin cast strip produced has a composition comprising, by weight, greater than 0.1% and not more than 0.5% carbon, greater than 0.01% and less than or equal to 0.15% phosphorus, between 0.9% and 2.0% manganese, between 0.05% and 0.50% silicon, and less than 0.01% aluminum,

(c) counter rotating the casting rolls to solidify metal shells on the casting rolls as the casting rolls move through the casting pool,

(d) forming a steel strip from the metal shells downwardly through the nip between the casting rolls,

(e) hot rolling the steel strip such that mechanical properties at 10% and 35% reduction are within 10% for yield strength, tensile strength and total elongation, and

(f) coiling the hot rolled steel strip at a temperature between 300 and 700° C. to provide a majority of the microstructure comprising bainite and acicular ferrite.

Alternatively, the step of hot rolling may be such that mechanical properties at 15% and 35% reduction are within 10% for yield strength, tensile strength and total elongation. In another alternative, the mechanical properties are within 10% throughout the range from 15% to 35% reduction for yield strength, tensile strength and total elongation. Alternatively, mechanical properties may be within 10% throughout the range from 10% to 35% reduction for yield strength, tensile strength and total elongation.

The molten steel composition may have a free oxygen content between 30 and 60 ppm. The total oxygen content of the molten metal for the hot rolled steel strip may be between 70 ppm and 150 ppm.

The molten steel may have a composition such that the carbon content of the composition of the hot rolled steel strip is less than 0.25% by weight. The molten steel may have a composition such that the manganese content of the composition of the hot rolled steel strip is between 0.9% and 1.3% by weight.

The molten steel having a composition such that the composition of the hot rolled steel strip may have in addition between 0.01% and 0.20% niobium by weight. Alternatively or in addition, the composition of molten steel may have a composition such that the composition of the hot rolled steel strip further comprises at least one element selected from the group consisting of molybdenum between about 0.05% and about 0.50%, vanadium between about 0.01% and about 0.20%, and a mixture thereof by weight.

A hot rolled steel strip may additionally be provided with a coating of zinc or a zinc alloy or aluminum. The hot rolled steel strip may also have a yield strength of at least 440 MPa after hot rolling reductions of at least 35%.

Also disclosed is a hot rolled steel strip and method of making the same comprising the steps of:

(a) assembling internally a cooled roll caster having laterally positioned casting rolls forming a nip between them,

(b) forming a casting pool of molten steel supported on the casting rolls above the nip and confined adjacent the ends of the casting rolls by side dams, the molten steel having a free oxygen content between 20 and 75 ppm and a composition such that the hot rolled steel strip has a composition comprising, by weight, greater than 0.1% and not more than 0.5% carbon, between 0.2% and 2.0% manganese, between 0.05% and 0.50% silicon, greater than 0.01% and less than or equal to 0.15% phosphorus, less than 0.03% tin, less than 0.20% nickel, less than 0.01% aluminum and between 0.20% and 0.60% copper,

(c) counter rotating the casting rolls to solidify metal shells on the casting rolls as the casting rolls move through the casting pool,

(d) forming a steel strip from the metal shells downwardly through the nip between the casting rolls,

(e) hot rolling the steel strip such that mechanical properties at 10% and 35% reduction are within 10% for yield strength, tensile strength and total elongation; and

(f) coiling the hot rolled steel strip at a temperature between 300 and 700° C. to provide a majority of the microstructure comprising bainite and acicular ferrite.

Alternatively, the step of hot rolling may be such that mechanical properties at 15% and 35% reduction are within 10% for yield strength, tensile strength and total elongation. In yet another alternative, the mechanical properties are within 10% throughout the range from 15% to 35% reduction for yield strength, tensile strength and total elongation. Alternatively, mechanical properties may be within 10% throughout the range from 10% to 35% reduction for yield strength, tensile strength and total elongation.

The molten steel may have a free oxygen content between 30 and 60 ppm. The total oxygen content of the molten metal for the hot rolled steel strip may be between 70 and 150 ppm. The nickel content may be less than 0.1% by weight.

The molten steel may have a composition such that the composition of the hot rolled steel strip has a copper content between 0.2% and 0.5% or between 0.3% and 0.4% by weight. The molten steel may in addition have a composition such that the composition of the hot rolled steel strip has additionally a chromium content between 0.4% and 0.75% or between 0.4% and 0.5% by weight.

The molten steel may have a composition such that the carbon content of the composition of the hot rolled steel strip is less than 0.25% by weight. The molten steel may have a composition such that the manganese content of the composition of the hot rolled steel strip is between 0.9% and 1.3% by weight.

The molten steel having a composition such that the composition of the hot rolled steel strip may have in addition between 0.01% and 0.20% niobium by weight. Alternatively or in addition, the composition of molten steel may have a composition such that the composition of the hot rolled steel strip further comprises at least one element selected from the group consisting of molybdenum between about 0.05% and about 0.50%, vanadium between about 0.01% and about 0.20%, and a mixture thereof by weight.

A hot rolled steel strip may additionally be provided with a coating of zinc or a zinc alloy or aluminum. The hot rolled steel strip may also have a yield strength of at least 440 MPa after hot rolling reductions of at least 35%.

### BRIEF DESCRIPTION OF THE DRAWINGS

FIG. 1 illustrates a strip casting installation incorporating an in-line hot rolling mill and coiler;

FIG. 2 illustrates details of the twin roll strip caster;

FIG. 3 is a graph showing the effect of hot rolling reduction on the yield strength for elevated manganese steel;

FIG. 4 is a graph showing the effect of hot rolling reduction on the yield strength and elongation for 0.19% carbon steel,

FIG. 5 is a graph showing the effect of amount of carbon on the tensile strength, yield strength and elongation for test samples between 0.88% and 1.1% manganese; and

FIG. 6 is a graph showing the effect of hot rolling reduction on the tensile strength, yield strength and elongation over reduction between about 15% and 45%.

### DETAILED DESCRIPTION OF THE DRAWINGS

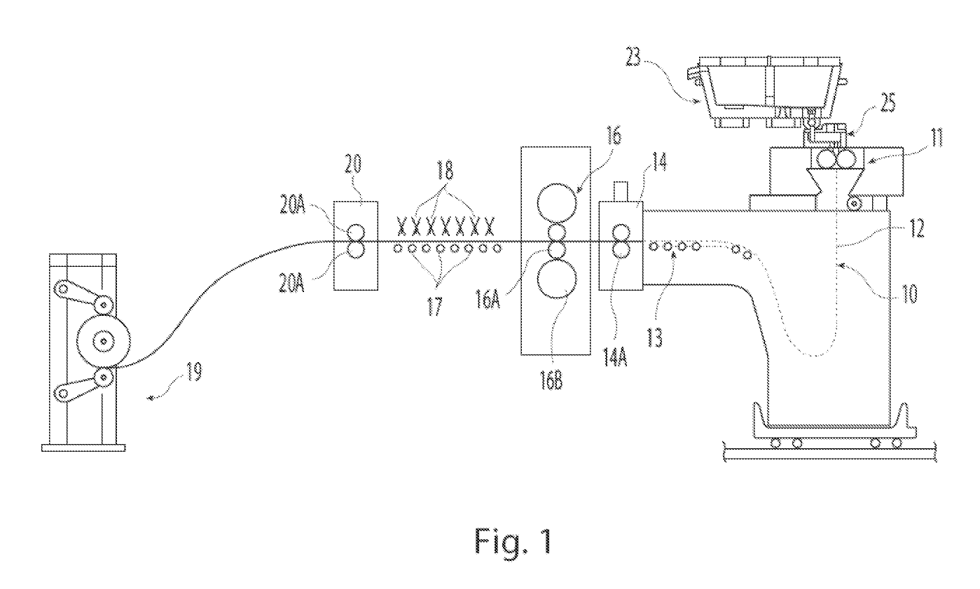

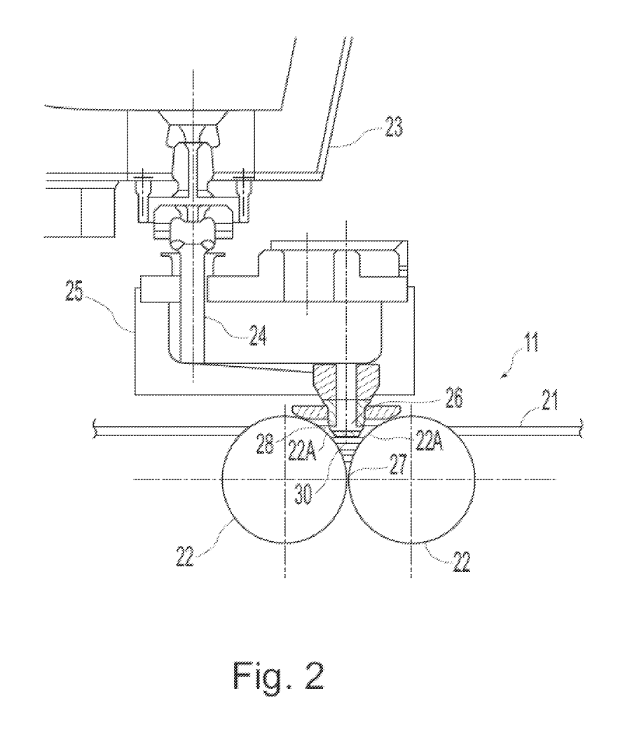

FIG. 1 illustrates successive parts of strip caster for continuously casting steel strip. FIGS. 1 and 2 illustrate a twin roll caster 11 that continuously produces a cast steel strip 12, which passes in a transit path 10 across a guide table 13 to a pinch roll stand 14 having pinch rolls 14A Immediately after exiting the pinch roll stand 14, the strip passes into a hot rolling mill 16 having a pair of reduction rolls 16A and backing rolls 16B where the cast strip is hot rolled to reduce a desired thickness. The hot rolled strip passes onto a run-out table 17 where the strip may be cooled by convection and contact with water supplied via water jets 18 (or other suitable means) and by radiation. The rolled and cooled strip then passes through a pinch roll stand 20 comprising a pair of pinch rolls 20A and then to a coiler 19. Final cooling of the cast strip takes place after coiling.

As shown in FIG. 2, twin roll caster 11 comprises a main machine frame 21, which supports a pair of laterally positioned casting rolls 22 having casting surfaces 22A. Molten metal is supplied during a casting operation from a ladle (not shown) to a tundish 23, through a refractory shroud 24 to a distributor or movable tundish 25, and then from the distributor 25 through a metal delivery nozzle 26 between the casting rolls 22 above the nip 27. The molten metal delivered between the casting rolls 22 forms a casting pool 30 above the nip. The casting pool 30 is restrained at the ends of the casting rolls by a pair of side closure dams or plates 28, which are pushed against the ends of the casting rolls by a pair of thrusters (not shown) including hydraulic cylinder units (not shown) connected to the side plate holders. The upper surface of casting pool 30 (generally referred to as the “meniscus” level) usually rises above the lower end of the delivery nozzle so that the lower end of the delivery nozzle is immersed within the casting pool 30. Casting rolls 22 are internally water cooled so that shells solidify on the moving roller surfaces as they pass through the casting pool, and are brought together at the nip 27 between them to produce the cast strip, which is delivered downwardly from the nip between the casting rolls.

The twin roll caster may be of the kind that is illustrated and described in some detail in U.S. Pat. Nos. 5,184,668 and 5,277,243 or U.S. Pat. No. 5,488,988, or U.S. patent application Ser. No. 12/050,987. Reference may be made to those patents for appropriate construction details of a twin roll caster appropriate for use in an embodiment of the present invention.

By employing rapid solidification rates with control of certain parameters, the present composition generates liquid deoxidation products of MnO and SiO₂ in a fine and uniform distribution of globular inclusions. In addition, the MnO.SiO₂ inclusions present are not significantly elongated by the in-line hot rolling process, due to limited hot reduction. The inclusion/particle populations are tailored to stimulate nucleation of acicular ferrite. The MnO.SiO₂ inclusions may be from 10 μm down to very fine particles of less than 0.1 μm, with a majority of the inclusions being between about 0.5 μm and 5 μm. The larger 0.5-10 μm size non-metallic inclusions are provided for nucleating acicular ferrite, and may include a mixture of inclusions, for example including MnS and CuS. The austenite grain size is significantly larger than the austenite grain size produced in conventional hot rolled strip steel. The coarse austenite grain size, in conjunction with the population of tailored inclusion/particles, assists with the nucleation of acicular ferrite and bainite.

The in-line hot rolling mill 16 is typically used for reductions of 10 to 50%. On the run-out-table 17 the cooling may include water cooling section and air mist cooling to control cooling rates of austenite transformation to achieve desired microstructure and material properties at a temperature between 300 and 700° C. Alternatively, the coiling temperature may be between about 450 and 550° C. The resulting microstructure comprises a majority acicular ferrite and bainite.

The effect of hot reduction on yield strength, tensile strength, and total elongation in the present elevated copper and elevated manganese steels results in steel properties where the tensile strength, yield strength and total elongation are relatively stable with different levels of hot reduction. In previous such steel products, there is typically a decrease in yield and tensile strengths with increasing hot reduction. In contrast, the effect of hot reduction on yield strength, tensile strength, and total elongation is significantly reduced in the present steel products. A coiling temperature below 550° C. may be used in conjunction with a high degree of hot rolling to mitigate the effect of hot reduction on the mechanical properties.

Hot reductions larger than about 15% can induce the recrystallization of austenite, which reduces the grain size and volume fraction of acicular ferrite and bainite. We have found that the addition of alloying elements increasing the hardenability of the steel suppresses the recrystallization of the coarse as-cast austenite grain size during the hot rolling process, and results in the hardenability of the steel being retained after hot rolling, enabling thinner material to be produced with the desired microstructure and mechanical properties over a wide range of percent hot reduction.

TABLE 1

| Steel | C | Mn | Si | Nb | V | N (ppm) |
|---|---|---|---|---|---|---|
| Base | 0.02-0.05 | 0.7-0.9 | 0.15-0.30 | <0.003 | <0.003 | 35-90 |
| J | 0.19 | 0.94 | 0.21 | <0.003 | <0.003 | 85 |
| L | 0.033 | 1.28 | 0.21 | <0.003 | <0.003 | <100 |

The molten composition of Steels J and L had a free oxygen content between 41 and 54 ppm and the compositions of Steel J and L had a greater than 0.01% and less than or equal to 0.15% phosphorus.

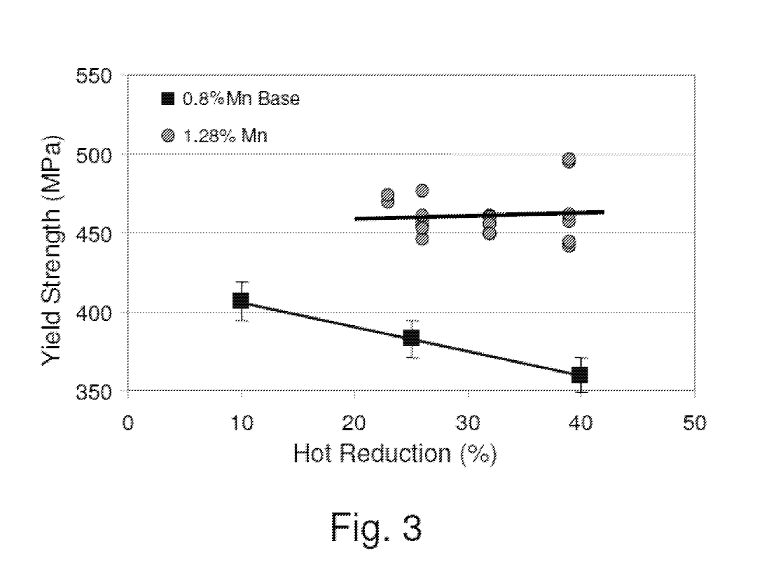

A typical composition for plain carbon-manganese steel includes a manganese content of about 0.60%-0.90% by weight. We have developed a steel composition having a substantially elevated manganese content (steel L in TABLE 1) to increase the hardenability of the steel. The elevated manganese content provides desired strength levels due to microstructural hardening. Additionally, manganese in solid solution acts to suppress static recrystallization of the deformed austenite after hot rolling, mitigating the effect of hot reduction on mechanical properties. This suppression is made possible by the short time scale and minimal hot reduction relative to slab based production. The present elevated manganese steel composition is relatively stable with the degree of hot rolled reduction for hot reductions up to at least 35%. This allows the production of thinner gauges, such as steel L having a thickness of 0.9 mm, with desired mechanical properties. As shown in FIG. 3, the yield strength for 1.28% manganese steel is less influenced by hot rolling reduction than a plain 0.8% carbon-manganese grade. Additionally, the yield strength of the 1.28% manganese was significantly higher than that of the base 0.8% manganese steel, exceeding 440 MPa for hot rolling reductions greater than 35%.

After hot rolling, the steel strip is cooled to a coiling temperature between about 300° C. and 700° C. to provide a majority of the microstructure comprising bainite and acicular ferrite. Alternatively, the steel strip is cooled to a coiling temperature between about 450° C. and 550° C. to provide a majority of the microstructure comprising bainite and acicular ferrite. The mechanical properties at 15% and 35% reduction are within 10% for yield strength, tensile strength and total elongation of the hot rolled strip. Alternatively, mechanical properties may be within 10% throughout the range from 15% to 35% reduction for yield strength, tensile strength and total elongation of the hot rolled strip.

The composition of the molten metal may be such that the carbon content of the hot rolled steel strip may include, by weight, greater than 0.1% and not more than 0.5% carbon, between 0.9% and 2.0% manganese, between 0.05% and 0.50% silicon, and less than 0.01% aluminum. The composition of the molten metal may be such that the carbon content of the hot rolled steel strip is less than 0.25% and manganese content may be between about 1.0% and 1.3% by weight.

Alternatively or in addition, the composition of the elevated manganese steel may include at least one element selected from the group consisting of niobium between about 0.01% and 0.2%, molybdenum between about 0.05% and about 0.50%, vanadium between about 0.01% and about 0.20%, and a mixture thereof. The hot rolled steel strip also may be hot dip coated to provide a coating of zinc or a zinc alloy or aluminum.

We also found that the desired microstructural hardening to reduce the effect of the hot rolling reduction on the mechanical properties can be provided by addition of between 0.20% and 0.60% copper and the manganese levels kept the same or reduced to as low as 0.08%, with less than 0.03% tin and less than 0.20% nickel by weight. This elevated copper steel enables use of steel scrap that is higher in copper, such as used in bar mills, to be used in the steel making without hot shortness. A number of trial heats were casted having copper levels in the range of 0.2% to 0.4%, and one trial heat of about 0.6% copper was casted without incurring hot shortness while also avoiding special practices or alloy additions.

The composition with copper may include, by weight, less than 0.25% carbon, between 0.2% and 2.0% manganese, between 0.05% and 0.50% silicon, less than 0.01% aluminum, less than 0.03% tin, less than 0.10% nickel, and between 0.20% and 0.60% copper. Alternatively, the copper content may be between about 0.2% and 0.5% by weight, and alternatively, may be between about 0.3% and 0.4%. Again, the molten steel cast has a free oxygen content between 20 and 75 ppm and the free oxygen content may be between 30 and 60 ppm. Again, the total oxygen content was between 70 ppm and 150 ppm.

The hot rolled steel strip may have, in addition, a chromium content between about 0.4% and 0.75% by weight. Alternatively, the chromium content may be between about 0.4% and 0.5%.

The modest increase in hardenability provided by copper was used, with less than 0.03% tin and less than 0.20% nickel, to produce a higher strength grade (Grade SS380) using high cooling rates and low coiling temperatures of between about 500° C. and 600° C. Alternatively, lower strength grades may be produced with elevated copper using low cooling rates and high coiling temperatures to offset the effect of the increased copper content. As shown in TABLE 2, tensile properties of grades with copper content between 0.20%-0.40% produced a range of galvanized structural grades, such as Grade SS275 to Grade SS380.

TABLE 2

| | | | Yield | Tensile | Total |
|---|---|---|---|---|---|
| | Coiling | Hot | Strength | Strength | Elongation |
| Mn (wt %) | temp. | reduction | (MPa) | (MPa) | (%) |
| 0.68-0.74 | 600-700° C. | 23-28% | 321 | 428 | 26.0 |
| 0.68-0.74 | 500-600° C. | 15-20% | 378 | 480 | 22.7 |
| 0.80-0.85 | 500-600° C. | 20-26% | 403 | 499 | 21.2 |

To produce lower strength grades with elevated copper, higher coiling temperatures between about 600 and 700° C. are used to offset the increased copper content. By coiling at increased temperatures, the present steel with elevated copper content may provide physical properties similar to plain carbon-manganese steel with low copper content. The present steel composition having elevated copper content can be made in electric arc furnaces with high copper scrap, as discussed above, at a considerable cost savings over low copper scrap.

In one alternative, the present elevated copper steel is hot dip coated with one or both of a zinc coating or a zinc alloy coating or an aluminum coating, such as a galvanized coating, Galvalume® and Zincalum® coating, aluminized coating or other coating. The microstructure of the present hot dipped elevated copper steel was not significantly altered as the strip temperatures remained well below the A_{c1} temperature of the steel. Consequently, the mechanical properties of uncoated elevated copper steel in the hot rolled condition are similar to the mechanical properties after coating on a continuous hot dip galvanizing line.

Alternatively or in addition, the high copper composition may include at least one element selected from the group consisting of niobium between about 0.01% and 0.2%, molybdenum between about 0.05% and about 0.50%, vanadium between about 0.01% and about 0.20%, and a mixture thereof.

In any case, carbon levels of about 0.20% and greater may also be used for applications where microalloying is not desired. Additionally, higher carbon levels, in the range of 0.30-0.50%, may be used in certain applications for material in the thickness range of 1.0-1.5 mm In the past, these elevated carbon steels required multiple annealing and cold rolling steps to achieve this thickness.

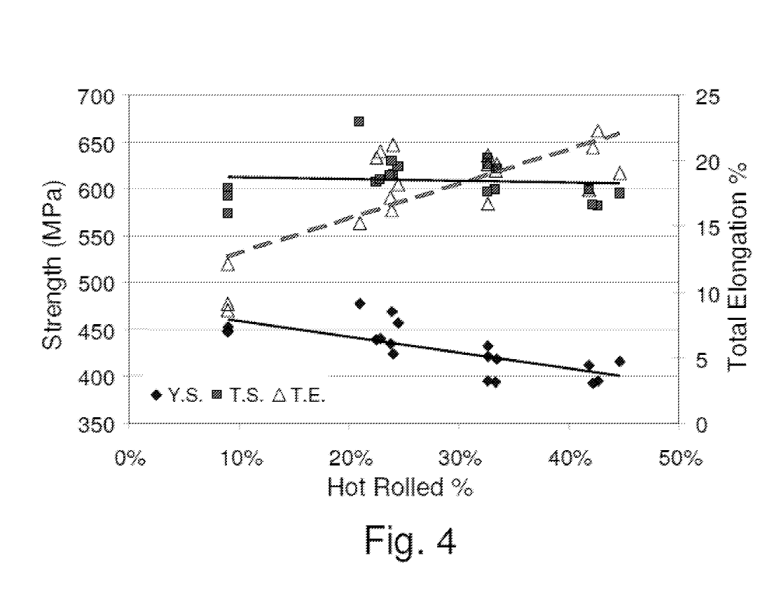

The composition of the 0.19% carbon steel is given in TABLE 1 (i.e. steel J) and the mechanical properties of yield strength (Y.S.), tensile strength (T.S.) and total elongation (T.E.) are presented in FIG. 4 as a function of the hot rolling reduction applied. The strength levels of the present 0.19% carbon steel are higher than current plain low carbon steels. As shown in FIG. 4, the yield strength is over 380 MPa over the full range of hot reductions applied, while being processed with conventional coiling temperatures. This is in contrast to low carbon steels (0.02-0.05% C), where lower coiling temperatures and limited hot reductions are applied to provide yield strengths over 380 MPa.

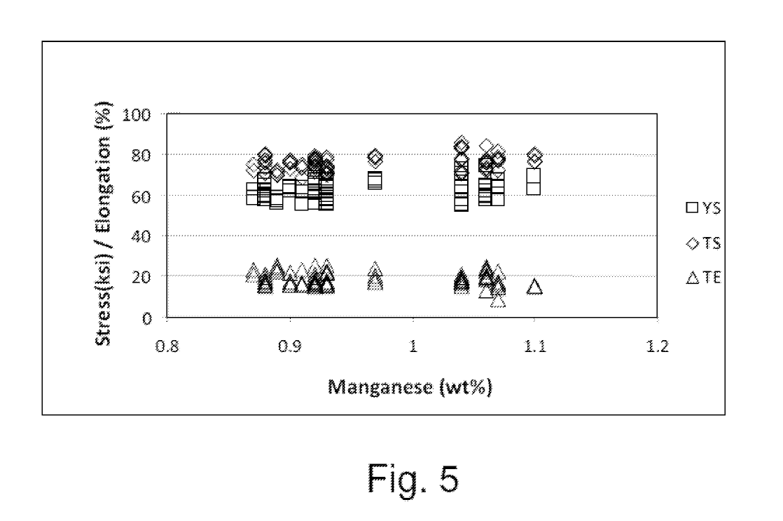

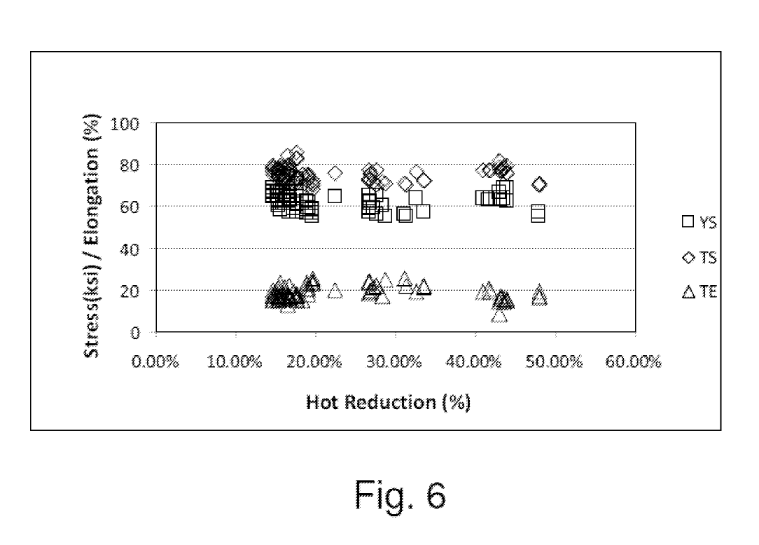

As illustrated in FIGS. 5 and 6, additional samples of the present steel were prepared with manganese content between about 0.88% and 1.1% and carbon content between about 0.02% and 0.04%. As shown in FIG. 5, the mechanical properties of tensile strength, yield strength and total elongation are relatively stable over different levels of manganese content between 0.88% and 1.1%.

The effect of hot reduction on yield strength, tensile strength, and total elongation in the present steels results in steel properties where the tensile strength, yield strength and total elongation are relatively stable with different levels of hot reduction, as shown in FIG. 6. As discussed above, in previous such steel products, there is typically a decrease in yield and tensile strengths with increasing hot reduction. In contrast, the effect of different amounts of hot reduction on yield strength, tensile strength, and total elongation is significantly reduced in the present steel products. As shown in FIG. 6, the present steel is relatively stable with hot rolled reductions up to at least 45%. The hot rolled cast strip is cooled to a temperature between 300 and 700° C., alternatively between about 450 and 550° C., to provide a microstructure comprising a majority bainite and acicular ferrite and having properties such that mechanical properties at 10% and 35% reduction are within 10% for yield strength, tensile strength and total elongation. Alternatively, mechanical properties may be within 10% throughout the range from 10% to 35% reduction for yield strength, tensile strength and total elongation. In yet another alternative, mechanical properties at 15% and 35% reduction may be within 10% for yield strength, tensile strength and total elongation. Alternatively, mechanical properties may be within 10% throughout the range from 15% to 35% reduction for yield strength, tensile strength and total elongation.

While the invention has been illustrated and described in detail in the foregoing drawings and description, the same is to be considered as illustrative and not restrictive in character, it being understood that only illustrative embodiments thereof have been shown and described, and that all changes and modifications that come within the spirit of the invention described by the following claims are desired to be protected. Additional features of the invention will become apparent to those skilled in the art upon consideration of the description. Modifications may be made without departing from the spirit and scope of the invention.

What is claimed is:

1. A hot rolled steel strip made by the steps comprising:
assembling an internally cooled roll caster having laterally positioned casting rolls forming a nip between them, and forming a casting pool of molten steel supported on the casting rolls above the nip and confined adjacent the ends of the casting rolls by side dams, the molten steel having a free oxygen content between 20 and 75 ppm and having a composition such that hot rolled thin cast strip produced has a composition comprising, by weight, less than 0.5% carbon, between 0.9% and 2.0% manganese, between 0.05% and 0.50% silicon, greater than 0.01% and less than or equal to 0.15% phosphorus, and less than 0.01% aluminum,
counter rotating the casting rolls to solidify metal shells on the casting rolls as the casting rolls move through the casting pool,
forming a steel strip from the metal shells downwardly through the nip between the casting rolls,
hot rolling the steel strip such that mechanical properties at 10% and 35% reduction are within 10% for yield strength, tensile strength and total elongation; and
coiling the hot rolled steel strip at a temperature between 300 and 700° C. to provide a majority of the microstructure comprising bainite and acicular ferrite.

2. The hot rolled steel strip as claimed in claim 1, the hot rolled steel strip such that mechanical properties at 15% and 35% reduction are within 10% for yield strength, tensile strength and total elongation.

3. The hot rolled steel strip as claimed in claim 1, the molten steel having a free oxygen content between 30 and 60 ppm.

4. The hot rolled steel strip as claimed in claim 1, the molten steel having a composition such that the manganese content of the composition of the hot rolled steel strip is between 0.9% and 1.3% by weight.

5. The hot rolled steel strip as claimed in claim 1, the molten steel having a composition such that the composition of the hot rolled steel strip has in addition between 0.01% and 0.20% niobium by weight.

6. The hot rolled steel strip as claimed in claim 1, the composition of molten steel having a composition such that the composition of the hot rolled steel strip further comprises at least one element selected from the group consisting of molybdenum between about 0.05% and about 0.50%, vanadium between about 0.01% and about 0.20%, and a mixture thereof by weight.

7. The hot rolled steel strip as claimed in claim 1 further comprising the step of:
hot dip coating the hot rolled steel strip to provide a coating of zinc or a zinc alloy or aluminum.

8. The hot rolled steel strip as claimed in claim 1 having a yield strength of at least 440 MPa after hot rolling reductions of at least 35%.

9. A hot rolled steel strip made by the steps comprising:
assembling an internally cooled roll caster having laterally positioned casting rolls forming a nip between them, and forming a casting pool of molten steel supported on the casting rolls above the nip and confined adjacent the ends of the casting rolls by side dams, the molten steel having a free oxygen content between 20 and 75 ppm and having a composition such that the composition of the hot rolled steel strip comprises, by weight, greater than 0.1% and not more than 0.5% carbon, greater than 0.01% and less than or equal to 0.15% phosphorus, less than 0.03% tin, less than 0.20% nickel, between 0.2% and 2.0% manganese, between 0.05% and 0.50% silicon, less than 0.01% aluminum, and between 0.20% and 0.60% copper,
counter rotating the casting rolls to solidify metal shells on the casting rolls as the casting rolls move through the casting pool,
forming a steel strip from the metal shells downwardly through the nip between the casting rolls,
hot rolling the steel strip such that mechanical properties at 10% and 35% reduction are within 10% for yield strength, tensile strength and total elongation; and
coiling the hot rolled steel strip at a temperature between 300 and 700° C. to provide a majority of the microstructure comprising bainite and acicular ferrite.

10. The hot rolled steel strip as claimed in claim 9, the hot rolled steel strip such that mechanical properties at 15% and 35% reduction are within 10% for yield strength, tensile strength and total elongation.

11. The hot rolled steel strip as claimed in claim 9, the molten steel having a free oxygen content of between 30 and 60 ppm.

12. The hot rolled steel strip as claimed in claim 9, the molten steel has a composition such that the composition of the hot rolled steel strip has a copper content between 0.2% and 0.5% by weight.

13. The hot rolled steel strip as claimed in claim 9, the molten steel has a composition such that the composition of the hot rolled steel strip has a copper content between 0.3% and 0.4% by weight.

14. The hot rolled steel strip as claimed in claim 9, the molten steel has a composition such that the composition of the hot rolled steel strip has a nickel content less than 0.1% by weight.

15. The hot rolled steel strip as claimed in claim 9, where the coiling temperature is between 600 and 700° C.

16. The hot rolled steel strip as claimed in claim 9, the molten steel has a composition such that the composition of the hot rolled steel strip has in addition a chromium content between 0.4% and 0.75% by weight.

17. The hot rolled steel strip as claimed in claim 9, the molten steel has a composition such that the composition of the hot rolled steel strip has in addition a chromium content between 0.4% and 0.5% by weight.

18. A method of making hot rolled steel strip, the steps comprising:
assembling an internally cooled roll caster having laterally positioned casting rolls forming a nip between them, and forming a casting pool of molten steel supported on the casting rolls above the nip and confined adjacent the ends of the casting rolls by side dams, the molten steel having a free oxygen content between 20 and 75 ppm and a composition such that hot rolled thin cast strip produced has a composition comprising, by weight, less than 0.25% carbon, greater than 0.01% and less than or equal to 0.15% phosphorus, between 1.0% and 2.0% manganese, between 0.05% and 0.50% silicon, less than 0.01% aluminum,
counter rotating the casting rolls to solidify metal shells on the casting rolls as the casting rolls move through the casting pool,
forming from the metal shells downwardly through the nip between the casting rolls a steel strip,
hot rolling the steel strip such that mechanical properties at 10% and 35% reduction are within 10% for yield strength, tensile strength and total elongation; and
coiling the hot rolled steel strip at a temperature between 300 and 700° C. to provide a majority of the microstructure comprising bainite and acicular ferrite.

19. The method of making hot rolled steel strip as claimed in claim 18, the step of hot rolling the steel strip such that mechanical properties at 15% and 35% reduction are within 10% for yield strength, tensile strength and total elongation.

20. The method of making hot rolled steel strip as claimed in claim 18, the molten steel having a free oxygen content between 30 and 60 ppm.

21. The method of making hot rolled steel strip as claimed in claim 18, the molten steel having a composition such that the manganese content of the composition of the hot rolled steel strip is between 0.9% and 1.3% by weight.

22. The method of making hot rolled steel strip as claimed in claim 18, the molten steel having a composition such that the composition of the hot rolled steel strip has in addition between 0.01% and 0.20% niobium by weight.

23. The method of making hot rolled steel strip as claimed in claim 18, the molten steel having a composition such that the composition of the hot rolled steel strip further comprises at least one element selected from the group consisting of molybdenum between about 0.05% and about 0.50%, vanadium between about 0.01% and about 0.20%, and a mixture thereof by weight.

24. The method of making hot rolled steel strip as claimed in claim 18 further comprising the step of:
hot dip coating the hot rolled steel strip to provide a coating of zinc or a zinc alloy or aluminum.

25. The method of making hot rolled steel strip as claimed in claim 18 having a yield strength of at least 440 MPa after hot rolling reductions of at least 35%.

26. A method of making hot rolled steel strip, the steps comprising:
assembling an internally cooled roll caster having laterally positioned casting rolls forming a nip between them, and forming a casting pool of molten steel supported on the casting rolls above the nip and confined adjacent the ends of the casting rolls by side dams, the molten steel having a free oxygen content between 20 and 75 ppm and, a composition such that the composition of the hot rolled steel strip comprises, by weight, less than 0.25% carbon, greater than 0.01% and less than or equal to 0.15% phosphorus, less than 0.03% tin, less than 0.20% nickel, between 0.2% and 2.0% manganese, between 0.05% and 0.50% silicon, less than 0.01% aluminum, and between 0.20% and 0.60% copper,
counter rotating the casting rolls to solidify metal shells on the casting rolls as the casting rolls move through the casting pool,
forming from the metal shells downwardly through the nip between the casting rolls a steel strip,
hot rolling the steel strip such that mechanical properties at 10% and 35% reduction are within 10% for yield strength, tensile strength and total elongation; and
coiling the hot rolled steel strip at a temperature between 300 and 700° C. to provide a majority of the microstructure comprising bainite and acicular ferrite.

27. The method of making hot rolled steel strip as claimed in claim 26, the step of hot rolling the steel strip such that mechanical properties at 15% and 35% reduction are within 10% for yield strength, tensile strength and total elongation.

28. The method of making hot rolled steel strip as claimed in claim 26, the molten steel having a free oxygen content of between 30 and 60 ppm.

29. The method of making hot rolled steel strip as claimed in claim 26, the molten steel having a composition such that the composition of the hot rolled steel strip has a copper content between 0.2% and 0.5% by weight.

30. The method of making hot rolled steel strip as claimed in claim 26, the molten steel having a composition such that the composition of the hot rolled steel strip has a copper content between 0.3% and 0.4% by weight.

31. The method of making hot rolled steel strip as claimed in claim 26, the molten steel having a composition such that the composition of the hot rolled steel strip has a nickel content less than 0.1% by weight.

32. The hot rolled steel strip as claimed in claim 29, where the coiling temperature is between 600 and 700° C.

33. The method of making hot rolled steel strip as claimed in claim 29, the molten steel having a composition such that the composition of the hot rolled steel strip has additional a chromium content between 0.4% and 0.75% by weight.

34. The method of making hot rolled steel strip as claimed in claim 29, the molten steel having a composition such that the composition of the hot rolled steel strip has additional a chromium content between 0.4% and 0.5% by weight.
